(19) United States
(12) Patent Application Publication
(10) Pub. No.: US 2006/0251770 A1
(43) Pub. Date: Nov. 9, 2006

(54) Celery pack

(76) Inventors: Robert P. Gray, Salinas, CA (US); Dean Diefenthaler, Newbury Park, CA (US); William Guy Munger JR., Salinas, CA (US); Manuel L. Alcala, Oxnard, CA (US); Daniel Saldivar, Oxnard, CA (US); Lauri Duda Buckley, Oviedo, FL (US)

Correspondence Address: JONDLE & ASSOCIATES P.C., 858 HAPPY CANYON ROAD SUITE 230, CASTLE ROCK, CO, 80108, US

(21) Appl. No.: 11/484,119

(22) Filed: Jul. 11, 2006

(51) Int. Cl. A23B 7/148

(52) U.S. Cl. 426/106

(57) ABSTRACT

A sanitized, ready-to-use and ready-to-eat celery pack is disclosed wherein the package consists of limbs that are from 6- to 14-inches in length and weigh from 0.25 to 1.6 pounds. The limbs are prepared by removing the butt end and the leaves, sorting the limbs according to length, sanitizing the limbs and packaging the limbs according to length. The limbs may or may not have joints depending on their length.

### BACKGROUND OF THE INVENTION

The present invention relates to a new and distinctive packaged ready-to-use and ready-to-eat celery product. All publications cited in this application are herein incorporated by reference.

Consuming a diet high in fruits and vegetables is associated with lower risks for numerous chronic diseases, including cancer and cardiovascular disease. In 1990, the Dietary Guidelines Committee recommended 3 or more servings of vegetables and 2 or more servings of fruit each day, and in 1991 the National Cancer Institute and the Produce for Better Health Foundation jointly established the national 5 A Day for Better Health Program. Since that time, all of the states and many national organizations have instituted programs to encourage people to increase their consumption of fruits and vegetables (Serdula, M. K., et al. 2004. Trends in Fruit and Vegetable Consumption Among Adults in the United States: Behavioral Risk Factor Surveillance System, 1994-2000. Amer. J. Pub. Health 94(6)). The national campaign to raise public awareness of the benefits of eating fruits and vegetables is leading to an increase in consumption of fruits and vegetables (5-a-day.org Press Release, Nov. 30, 2005).

Consumers demand convenience food items and this includes fresh vegetables. Whole and subdivided vegetables which, as purchased, are suitable for immediate consumption or for further processing by consumers are highly desirable. Many consumers do not want to spend time removing roots, leaves or other parts of vegetables in order to make the vegetables edible. It would be very desirable to have additional vegetable methods and products which allow consumers to be able to eat the vegetables straight out of the package, or have them ready for use with minimum preparation.

The foregoing examples of the related art and limitations related therewith are intended to be illustrative and not exclusive. Other limitations of the related art will become apparent to those of skill in the art upon a reading of the specification.

### SUMMARY OF THE INVENTION

The following embodiments and aspects thereof are described in conjunction with systems, tools, and methods which are meant to be exemplary and illustrative, not limiting in scope. In various embodiments, one or more of the above-described problems have been reduced or eliminated, while other embodiments are directed to other improvements.

According to the invention, there is provided a packaged sanitized ready-to-use and ready-to-eat celery product, wherein said product is between 6 and 14 inches long, said product being prepared by selecting said celery, cutting said celery so as to remove top leaves, cutting said celery so as to remove all attachment to butt of celery, removing the heart of said celery, cutting said celery into lengths between 6 and 14 inches, sanitizing said celery, and packaging said celery.

In another aspect, the present invention provides a sanitized ready-to-use and ready-to-eat celery product, wherein said product is between 6 and 8 inches long.

In another aspect, the present invention provides a sanitized ready-to-use and ready-to-eat celery product, wherein said product is between 8 and 10 inches long.

In another aspect, the present invention provides a sanitized ready-to-use and ready-to-eat celery product, wherein said product is between 10 and 12 inches long.

In another aspect, the present invention provides a sanitized ready-to-use and ready-to-eat celery product, wherein said product is between 12 and 14 inches long.

In another aspect, the present invention provides a sanitized ready-to-use and ready-to-eat celery product, wherein said product weighs between 0.25 and 1.6 pounds.

In addition to the exemplary aspects and embodiments described above, further aspects and embodiments will become apparent by reference by the study of the following descriptions.

### DEFINITIONS

In the description and tables which follow, a number of terms are used. In order to provide a clear and consistent understanding of the specification and claims, including the scope to be given such terms, the following definitions are provided:

Attachment to butt. Attachment to butt means the area of the celery where the petioles are attached to the butt of the plant. This generally includes the flare of the petiole which is the usually white, flared lower portion of the petiole which is about two to three inches above the butt.

Brown Stem. At or near maturity, or sometimes as a response to injury, the outer petioles will have an internal brown discoloration which is brown stem. This is a discoloration associated with bacterial breakdown which becomes systemic. There are genetic differences for the proclivity to brown stem.

Butt. The butt is the lower portion of the plant where the roots and the petioles meet.

Carton Size. Carton size does not actually refer to the size of the carton but refers to the number of celery stalks it contains. Celery is packaged according to size in increments of ½ dozen count. For example a 3 dozen size carton of celery contains 3 dozen stalks, a 2½ dozen carton contains 2½ dozen stalks, a 2 dozen carton contains 2 dozen stalks and a 1½ dozen carton contains 1½ dozen stalks.

Celery sticks. Celery sticks are small segments of the celery limb, around 3 to 5 inches in length. (See U.S. Pat. No. 4,753,808) Generally two or more sticks are generated from a single limb and the joint and flare are not present. These are generally sold in small portion/package sizes as ready-to-eat and consumption is as is, i.e. for dipping. They are not a substitute for whole stalk celery.

Consumer. Consumer means the end user.

Customer. Customer means the retailer that is purchasing a product for resale (e.g. a grocery store).

Feather Leaf. At or near maturity some of the leaves generally located on the outer petioles may start to senesce and become more yellow in color. There are genetic differences which cause feather leaf.

Flare. The generally wider, lower portion of the petiole which is usually pale green or white and is approximately 1.5 to 3 inches long and having a width of 3 inches or less.

Heart. Heart refers to those petioles having the leaf intact that measure less than 40 cm from petiole base to leaf tip.

Joint. The joint is that point at the top of the petiole where the leaves are attached. Since the leaf blades are attached at the joint with a stem it is possible to remove the leaves while leaving the joint intact.

Limb. The limb is the petiole excluding the leaves and the attachment to the butt. It may or may not include the flare or the joint. A celery branch is another term used to describe a celery limb. The celery limb ranges from 6.0, 6.1, 6.2, 6.3, 6.4, 6.5, 6.6, 6.7, 6.8, 6.9, 7.0, 7.1, 7.2, 7.3, 7.4, 7.5, 7.6, 7.7, 7.8, 7.9, 8.0, 8.1, 8.2, 8.3, 8.4, 8.5, 8.6, 8 7, 8.8, 8.9, 9.0, 9.1, 9.2, 9.3, 9.4, 9.5, 9.6, 9.7, 9.8, 9.9, 10.0, 10.1, 10.2, 10.3, 10.4, 10.5, 10.6, 10.7, 10.8, 10.9, 11.0, 11.1, 11.2, 11.3, 11.4, 11.5, 11.6, 11.7, 11.8, 11.9, 12.0, 12.1, 12.3, 12.4, 12.5, 12.6, 12.7, 12.8, 12.9, 13.0, 13.1, 13.2, 13.3, 13.4, 13.5, 13.6, 13.7, 13.8, 13.9, to 14.0 inches and all fractions thereof.

Maturity Date. Maturity in celery can be affected by two conditions. The first, or true maturity, is the point in time when the celery reaches maximum size distribution, but before defects such as pith, yellowing, Feather Leaf or Brown Stem appear. The second, or market maturity is an artificial maturity dictated by market conditions, i.e, the market requirement may be for 3 dozen sizes so the field is harvested at slightly below maximum yield potential because the smaller sizes are what the customers prefer at that moment.

Packaged. The celery limbs are packaged according to length and may be packaged in any number of methods according to the specifications of the customer. The product may be packaged and sealed in flexible films, including sleeves or bags that may or may not be resealable, rigid plastic containers like clam shells, solid fiber containers, poly sleeves, plastic sleeves, poly bags, plastic bags, natural decomposable bags, natural decomposable sleeves, or any combination thereof. Variations in the packaging may include different gas exchange rates which may occur due to different permeability or transmission properties of the package materials themselves or due to vents or specialized pores built into the packaging. The package weight ranges from 0.25, 0.26, 0.27, 0.28, 0.29, 0.30, 0.31, 0.32, 0.33, 0.34, 0.35, 0.36, 0.37, 0.38, 0.39, 0.40, 0.41, 0.42, 0.43, 0.44, 0.45, 0.46, 0.47, 0.48, 0.49, 0.50, 0.51, 0.52, 0.53, 0.54, 0.55, 0.56, 0.57, 0.58, 0.59, 0.60, 0.61, 0.62, 0.63, 0.64, 0.65, 0.66, 0.67, 0.68, 0.69, 0.70, 0.71, 0.72, 0.73, 0.74, 0.75, 0.76, 0.77, 0.78, 0.79, 0.80, 0.81, 0.82, 0.83, 0.84, 0.85, 0.86, 087, 0.88, 0.89, 0.90, 0.91, 0.92, 0.93, 0.94, 0.95, 0.96, 0.97, 0.98, 0.99, 1.00, 1.01, 1.02, 1.03, 1.04, 1.05, 1.06, 1.07, 1.08, 1.09, 1.10, 1.11, 1.12, 1.13, 1.14, 1.15, 1.16, 1.17, 1.18, 1.19, 1.20, 1.21, 1.22, 1.23, 1.24, 1.25, 1.26, 1.27, 1.28, 1.29, 1.30, 1.31, 1.32, 1.33, 1.34, 1.35, 1.36, 1.37, 1.38, 1.39, 1.40, 1.41, 1.42, 1.43, 1.44, 1.45, 1.46, 1.47, 1.48, 1.49, 1.50, 1.51, 1.52, 1.53, 1.54, 1.55, 1.56, 1.57, 1.58, 1.59, to 1.60 pounds and all fractions thereof.

Packaged celerv heart. Packaged celery heart is a packaged product which contains the celery heart made from 4 to 6 dozen count celery stalks generally packaged as two or three stalks packaged in a single poly/plastic sleeve. They are generally 7 inches to 9 inches in length.

Petiole. A petiole is the stem or limb of a leaf, the primary portion of the celery consumed.

Pith. Pith is a sponginess/hollowness/white discoloration that occurs in the petioles of varieties naturally as they become over-mature. In some varieties it occurs at an earlier stage causing harvest to occur prior to ideal maturity. Pith generally occurs in the outer older petioles first. If it occurs, these petioles are stripped off to make grade and effectively decreases the stalk size and overall yield potential.

Plant Height. The height of the plant from the base or butt of the celery plant to the top of the tallest leaf.

Product. A sanitized ready-to-use and ready-to-eat package of celery containing only the most desirable portion of the celery stalk, the celery limbs. Limb length and package weight may vary depending on the customer's specifications and variety or stalk size utilized to generate the product.

Product 6 inches in length. Product 6 inches in length means a celery product 5.5, 5.6, 5.7, 5.8, 5.9, 6.0, 6.1, 6.2, 6.3 and 6.4 inches long and all integers and fractions thereof.

Product of 7 inches in length. Product 7 inches in length means a celery product 6.5, 6.6, 6.7, 6.8, 6.9, 7.0, 7.1, 7.2, 7.3 and 7.4 inches long and all integers and fractions thereof.

Product 8 inches in length. Product 8 inches in length means a celery product 7.5, 7.6, 7.7, 7.8, 7.9, 8.0, 8.1, 8.2, 8.3 and 8.4 inches long and all integers and fractions thereof.

Product 9 inches in length. Product 9 inches in length means a celery product 8.5, 8.6, 8.7, 8.8, 8.9, 9.0, 9.1, 9.2, 9.3 and 9.4 inches long and all integers and fractions thereof.

Product 10 inches in length. Product 10 inches in length means a celery product 9.5, 9.6, 9.7, 9.8, 9.9, 10.0, 10.1, 10.2, 10.3 and 10.4 inches long and all integers and fractions thereof.

Product 11 inches in length. Product 11 inches in length means a celery product 10.5, 10.6, 10.7, 10.8, 10.9, 11.0, 11.1, 11.2, 11.3 and 11.4 inches long and all integers and fractions thereof.

Product 12 inches in length. Product 12 inches in length means a celery product 11.5, 11.6, 11.7, 11.8, 11.9, 12.0, 12.1, 12.2, 12.3 and 12.4 inches long and all integers and fractions thereof.

Product 13 inches in length. Product 13 inches in length means a celery product 12.5, 12.6, 12.7, 12.8, 12.9, 13.0, 13.1, 13.2, 13.3 and 13.4 inches long and all integers and fractions thereof.

Product 14 inches in length. Product 14 inches in length means a celery product 13.5, 13.6, 13.7, 13.8, 13.9, 14.0, 14.1, 14.2, 14.3 and 14.4 inches long and all integers and fractions thereof.

Ready-to-eat. The product is sanitized and made ready to consume, as is, right out of the package.

Ready-to-use. The product is sanitized and made ready so the consumer need only to remove it from the package and, depending on the desired use or recipe, chop, cut or slice it. No cleaning or separation of different parts of the celery stalk is required.

Sanitized. Sanitized means washed, cleansed or sterilized so the limb's surface is free of dirt, insects, microbial infestation, bacterial infestation, fungal infestation or other surface contaminates. The process of sanitization involves washing the limbs in order to remove surface contamination such as dirt and insects and the utilization of a sanitization material or process in order to remove or kill surface contamination by microbial, bacterial and fungal agents.

Sanitization Treatment. Sanitization treatment means treating the celery with a chemical or process so as to sanitize the celery. The chemical or process is selected from the group consisting of ascorbic acid, peroxyacetic acid also known as TSUNAMI, sodium hypochlorite (chlorine), bromine products (sodium hypobromine), chlorine dioxide, ozone based systems, hydrogen peroxide products, trisodium phosphate, quaternary ammonium products, ultraviolet light systems, irradiation, steam, ultra heat treatments, and high pressure pasteurization.

Stalk. A stalk is a single entire celery plant with multiple petioles that has some foliage and has the roots removed but has the butt intact.

Top leaves. Top leaves are those leaves that are located at the top of the stalk. Distinguished from the leaves of the heart which are still located within the stalk.

### DETAILED DESCRIPTION OF THE INVENTION

The present invention is a ready-to-use and ready-to-eat, sanitized celery product consisting of celery limbs in a sealed package. All limbs in a single package of the present invention are the same length, but package lengths offered may vary depending on the customer's preference. The present invention is an important replacement for whole stalk celery. The present invention embodies both a product of the whole stalk minus the less desirable portions of whole stalk celery (i.e. leaf, heart, butt) and a method for making the same.

By offering different lengths or package weights to the customer, the customer is best able to purchase a product that fits the particular demands of their particular consumer base. For example a retailer that services a convenience store consumer base may prefer to have a smaller product because its particular consumers are buying smaller portions for a single meal or recipe. A larger retail customer may prefer a larger product package that represents a 2-dozen count size celery stalk because its consumers are purchasing groceries to last a week of food preparation and meals for larger families.

By eliminating the heart, foliage, basal plate or butt of the plant and, depending on the customer, a portion or all of the flare, the present invention not only is an improved product but also the weight of the present invention is significantly reduced compared to the original stalks from which it was generated. This provides an unexpected additional advantage of reducing shipment costs. This is particularly critical as shipping costs escalate due to increasing fuel costs, especially when shipping product from coast to coast.

By creating a product which includes only the most desirable portion of the celery stalk, the limbs, the product volume is significantly reduced. This is also very beneficial to the consumer because there is less space utilized in the refrigerator for storage. It is also beneficial to the customer because it takes up less space on the produce display in the store and reduces cost.

By creating a product which includes only the most desirable portion of the celery stalk that is ready-to-use by the consumer, less input is required to prepare the product for consumption or recipes. This is beneficial to the consumer because there is less waste, less time involved in preparation for consumption and a greater likelihood that the consumer will utilize the entire product. By improving the likelihood that the product will be utilized, the dietary intake of the consumer is improved.

By removing the leaves and the growing point from the celery, unexpectedly the quality of this finished product is improved. Even under conditions of refrigeration, a celery stalk containing the growing point, which is a part of the heart and exists at the center of the butt, is still a living organism. When cut or injured a celery stalk begins translocating its nutritional reserves and sugars from the outside limbs to the growing point. (See Zamski, et al. 2001. Analysis of celery (Apium graveolens) mannitol dehydrogenase (Mtd) promoter regulation in Arabidopsis suggests roles for MTD in key environmental and metabolic responses. Plant Mol. Biol. 47:621-631; Noiraud, N. et al. 2000. The Sucrose Transporter of Celery. Identification and Expression During Salt Stress. Plant Phys. 122:1447-1455.) While under refrigeration this process is slowed but it does not completely stop. By removing the butt, heart and leaves there is nowhere for these reserves to be translocated and the quality of the preferred portion of the celery stalk for consumption is unexpectedly improved.

### EXAMPLES

### Example 1

### Process of Generating 6- to 14-inch Limbs Using the Method of the Present Invention

Prior to the present invention, celery products available were whole celery stalks or celery sticks. Whole celery stalks include the butt, heart and leaves. Celery sticks are 3-5 inches long and are often packaged with other vegetables into party trays. The number of 4-inch sticks that can be obtained from a celery stalk depends on the number of limbs in that stalk and the length of the limbs in that stalk. Table 1 below shows the average and range of number of limbs and the average and range of number of 4-inch sticks generated from different celery varieties.

TABLE 1
Average and Range of Limbs & Sticks

| | | | No. 4-inch |
|---|---|---|---|
| Variety | | No. Limbs | Sticks |
| Hill's Special | Average | 9.1 | 16.2 |
| | Range | 8-10 | 13-18 |
| Sonora | Average | 10.3 | 17.9 |
| | Range | 8-12 | 11-22 |
| ADS-12 | Average | 11.1 | 23.5 |
| | Range | 9-14 | 18-27 |
| ADS-5 | Average | 10.1 | 16.0 |
| | Range | 8-11 | 13-18 |
| ADS-16 | Average | 12.5 | 30.4 |
| | Range | 11-14 | 25-36 |
| ADS-11 | Average | 10.4 | 26.7 |
| | Range | 8-13 | 19-40 |
| ADS-4 | Average | 10.8 | 32.6 |
| | Range | 10-14 | 21-42 |
| ADS-13 | Average | 13.3 | 33.6 |
| | Range | 11-18 | 25-50 |
| ADS-17 | Average | 12.8 | 43.4 |
| | Range | 10-14 | 32-53 |
| ADS-18 | Average | 10.7 | 31.6 |
| | Range | 9-12 | 29-45 |

According to the method of the present invention, a whole celery stalk is trimmed to meet the customer's length specification while simultaneously removing the butt and foliage. Limbs meeting the specifications may be sorted and packaged. Joints may or may not be present depending on the desired length of the limbs. For example, taller varieties may be able to generate 14-inch limbs without a joint while the joint is more likely to be present in shorter varieties. Before being packaged, limbs are sanitized so that they are ready-to-use and ready-to-eat when received by the consumer. The stalk is trimmed by any number of procedures which include, but are not limited to, the following: cutting by knives, razor sharp blades, saws, water jets, lasers and sound waves.

In the method of the present invention, a whole celery stalk is trimmed to remove the butt and foliage. The remaining limbs may then be trimmed to meet the customer's specifications for length and sorted and packaged. Joints may or may not be present depending on the desired length of the limbs. For example, taller varieties may be able to generate 14-inch limbs without a joint while the joint is more likely to be present in shorter varieties. Before being packaged, limbs are sanitized so that they are ready-to-use and ready-to-eat when received by the consumer. The stalk and limbs may be trimmed by any number of procedures which include, but are not limited to, the following: cutting by knives, razor sharp blades, saws, water jets, lasers and sound waves. See, for example, U.S. Pat. Nos. 3,974725, 4,601156, 4,753808, 6,308600, 4,751094, and 5,916354.

Limbs may be sanitized by any number of methods which include but are not limited to, the following: ascorbic acid and peroxyacetic acid also known as TSUNAMI, sodium hypochlorite (chlorine), bromine products (sodium hypobromine), chlorine dioxide, ozone based systems, hydrogen peroxide products, trisodium phosphate, quaternary ammonium products, ultraviolet light systems, irradiation, steam, ultra heat treatments, and high pressure pasteurization. See, for example, U.S. Pat. Nos. 5,945,146 and 4,753,808 and US Publication No. 2004/0191382, Zagory, D. 1999. Sanitation Concerns in the Fresh-cut Fruit and Vegetable Industry. Paper presented at the University of California, Davis, Food Processors Sanitation Workshop, Feb. 3 and 4, 1999. Modesto, Calif., a copy of which can be found at www.davisfreshtech. com/articles_freshcut.html; Suslow, T. Chlorination in the Production and Postharvest Handling of Fresh Fruits and Vegetables, University of California, Davis, a copy of which can be found at http://ucce.ucdavis.edu/files/filelibrary/5453/4369.pdf; Liao, C., Cooke, P.H. 2001. Response to Trisodium Phosphate Treatment of Salmonella Chester Attached to Fresh-Cut Green Pepper Slices. Canadian J. Micro. 47:25-32; Jongen, W., ed. 2005. Improving the Safety of Fresh Fruit and Vegetables. C.H.I.P.S., Weimar, Tex.

With the method of the present invention, once limbs are sanitized they are packaged according to length and may be packaged in any number of methods according to the specifications of the customer. During the packaging process, the heart is removed. The heart is identified by the presence of leaves or a paler color (than that of the outer petioles) often associated with the heart that is not acceptable. The product of the present invention may be packaged in numerous types of packages including but not limited to riged plastic, flexible film, solid fiber packages or any combination thereof. Variations in the packaging may include different gas exchange rates which may occur due to different permeability or transmission properties of the package materials themselves or due to vents or specialized pores built into the packaging. See for example, U.S. Pat. Nos. 4,753,808, and 4,586,313.

The present invention may or may not be packaged with modified atmospheric conditions within the package, i.e. gaseous nitrogen may be utilized to displace the oxygen in the package to improve shelf stability.

### Example 2

### Limb Lengths Generated using the Method of the Present Invention

All limbs generated by the method of the present invention are the same length, but limb lengths offered may vary depending on the customer's preference. The 6-inch limb product results from the production of limbs from either celery hearts, which are generally 9 inches in length, or from the shortest celery acceptable in the “United States Standards for Grades of Celery” [U.S. Extra No.1 (Minimum average 7-inch joint) or U.S. No.1 (Minimum average 6-inch joint)]. When a 7-inch average length celery or a 9-inch celery heart is trimmed to remove the butt and a portion of the flare and a clean sanitized cut of the upper portion of the limb is made, what remains is a 6-inch to 7-inch limb.

The 14-inch limb product of the present invention is desirable because consumers currently accept 14 inches as a standard for whole stalk celery. Only a few commercially available celery varieties are long enough to allow for the creation of 14-inch limbs. Several varieties proprietary to the applicant (ADS-3, U.S. Ser. No. 10/727,914, ADS-11, U.S. Ser. No. 11/326,237, ADS-12, U.S. Ser. No. 11/373,964 and ADS-13, U.S. Ser. No. 11/342,477, ADS-16, ADS-17, ADS-18) are long enough to allow the creation of such limbs.

Celery limbs between 6 inches and 14 inches are also within the scope of the present invention since many celery varieties have different length to joint and subsequently different length to leaf blade attachment. Further, different varieties respond differently under different production conditions and environments so the length of the limb able to be packaged may vary. Table 2 below shows the average joint length and range of joint lengths in inches of petioles from butt to joint for different celery varieties grown under relatively ideal conditions.

TABLE 2
Celery Joint Average & Range Length

| | Joint | Joint |
|---|---|---|
| Variety | Length | Range |
| Sonora | 12.2 | 11-13 |
| Hill's Special | 13.1 | 12-14 |
| ADS-2 | 10.6 | 10-11 |
| ADS-8 | 10.1 | 10-11 |
| ADS-12 | 14.4 | 14-16 |
| ADS-5 | 12.5 | 12-15 |
| ADS-16 | 16.6 | 15-18 |
| ADS-3 | 15.1 | 13-16 |
| ADS-4 | 19.4 | 18-21 |
| ADS-11 | 19.8 | 19-21 |
| ADS-13 | 17.8 | 16-19 |
| ADS-17 | 21.9 | 20-24 |
| ADS-18 | 20.6 | 19-22 |

### Example 3

### Number of Limbs Generated by the Method of the Present Invention

The number of limbs that meet the specifications of the present invention obtainable from a stalk of celery will vary depending on the size of the stalk, the variety, the maturity and the production conditions. This applicant has demonstrated in previous patent applications (ADS-1, U.S. Pat. No. 6,822,143, ADS-8, U.S. Pat. No. 6,812,385, ADS-7, U.S. Pat. No. 6,818,810, ADS-3, U.S. Ser. No. 10/727,914, ADS-4, U.S. Pat. No. 7,057,099, ADS-5, U.S. Pat. No. 6,967,266, ADS-11, U.S. Ser. No. 11/326,237, ADS-12, U.S. Ser. No. 11/373,964 and ADS-13, U.S. Ser. No. 11/342,477), herein incorporated by reference, that the number of limbs present in a stalk of celery varies considerably between different varieties as does the width and thickness of the limbs. The length of the limb to be produced for any particular customer would also have an effect on the number of useable limbs that could be potentially produced from a stalk of celery. If a shorter length celery limb product was desired by the customer more limbs in a stalk are likely to be able to meet the specifications of the product than a longer limb length.

Table 3 below shows the variation in the number of limbs that can be generated from different varieties and the variation that exists within different varieties with different limb lengths for a two-dozen count celery size. Column 1 shows the variety, column 2 shows the average number and limb count range, column 3 shows the number of limbs that can be generated for a product with a 6-inch specification, column 4 shows the number of limbs that can be generated for a product with an 8-inch specification, column 5 shows the number of limbs that can be generated for a product with a 10-inch specification, column 6 shows number of limbs that can be generated for a product with a 12-inch specification, and column 7 shows number of limbs that can be generated for a product with a 14-inch specification.

TABLE 3
Celery Limb Number, Average & Range, for Each Limb Length

| Variety | | 6-inch | 8-inch | 10-inch | 12-inch | 14-inch |
|---|---|---|---|---|---|---|
| Sonora | Average | 10.2 | 10.2 | 9.8 | 2.5 | 0 |
| | Range | 8-13 | 8-13 | 7-12 | 0-5 | 0 |
| Hill's Special | Average | 11.1 | 11.1 | 10.3 | 8.4 | 0 |
| | Range | 9-12 | 9-12 | 8-12 | 7-10 | 0 |
| ADS-2 | Average | 10 | 9.8 | 4.8 | 0 | 0 |
| | Range | 9-11 | 8-9 | 2-7 | 0 | 0 |
| ADS-8 | Average | 12.7 | 10.6 | 3.9 | 0 | 0 |
| | Range | 11-14 | 9-11 | 1-10 | 0 | 0 |
| ADS-12 | Average | 11.2 | 11.2 | 11.2 | 10.3 | 4.7 |
| | Range | 9-14 | 9-14 | 9-14 | 7-14 | 1-8 |
| ADS-5 | Average | 9.3 | 9.3 | 9.0 | 7.0 | 2.2 |
| | Range | 7-12 | 7-12 | 6-12 | 5-9 | 0-6 |
| ADS-16 | Average | 10.7 | 10.7 | 10.7 | 10.7 | 8.7 |
| | Range | 7-14 | 7-14 | 7-14 | 7-14 | 6-12 |
| ADS-4 | Average | 12.5 | 12.5 | 12.5 | 11.0 | 9.6 |
| | Range | 9-13 | 9-13 | 9-13 | 9-13 | 9-11 |
| ADS-11 | Average | 9.3 | 9.3 | 9.3 | 9.3 | 9.0 |
| | Range | 8-12 | 8-12 | 8-12 | 8-12 | 8-11 |
| ADS-13 | Average | 10 | 10 | 10 | 10 | 5.5 |
| | Range | 9-11 | 9-11 | 9-11 | 9-11 | 2-7 |
| ADS-17 | Average | 11.2 | 11.2 | 11.2 | 11.2 | 11.2 |
| | Range | 9-14 | 9-14 | 9-14 | 9-14 | 9-14 |
| ADS-18 | Average | 8.9 | 8.9 | 8.9 | 8.9 | 8.9 |
| | Range | 7-12 | 7-12 | 7-12 | 7-12 | 7-12 |

### Example 4

### Number of Limbs Generated by the Method of the Present Invention

Table 4 below shows the average number of limbs and the range using the method of the present invention generated from celery variety ADS-2 (U.S. patent application Ser. No. 10/727,913) from a two-dozen count stalk, a three-dozen count stalk and from a heart stalk. Column 1 shows the size carton, column 2 shows the average number of limbs and the range, column 3 shows average number of limbs and the range that can be generated for a product with a 6-inch specification, column 4 shows the average number of limbs and the range that can be generated for a product with an 8-inch specification, column 5 shows the average number of limbs and the range that can be generated for a product with a 10-inch specification, column 6 shows the average number of limbs and the range that can be generated for a product with a 12-inch specification and column 7 shows the average number of limbs and the range that can be generated for a product with a 14-inch specification.

TABLE 4
Celery Limb Number, Average & Range, for Each Limb Length
ADS-2

| | | 6-inch | 8-inch | 10-inch | 12-inch | 14-inch |
|---|---|---|---|---|---|---|
| 2-Dozen Cnt. | Average | 10 | 9.8 | 4.8 | 0 | 0 |
| | Range | 9-11 | 8-9 | 2-7 | 0 | 0 |
| 3-Dozen Cnt | Average | 7.6 | 6.6 | 3.8 | 0 | 0 |
| | Range | 7-9 | 5-7 | 2-5 | 0 | 0 |
| Hearts | Average | 5.4 | 4.6 | 0 | 0 | 0 |
| | Range | 5-6 | 4-5 | 0 | 0 | 0 |

### Example 5

### Number of Limbs Generated by the Method of the Present Invention

Table 5 below shows the average number of limbs and the range using the method of the present invention generated from celery variety ADS-8 (U.S. Pat. No. 6,812,385) from a two-dozen count stalk, a three-dozen count stalk and from a heart stalk. Column 1 shows the size carton, column 2 shows the average number of limbs and the range, column 3 shows average number of limbs and the range that can be generated for a product with a 6-inch specification, column 4 shows the average number of limbs and the range that can be generated for a product with an 8-inch specification, and column 5 shows the average number of limbs and the range that can be generated for a product with a 10-inch specification.

TABLE 5
Celery Limb Number, Average & Range, for Each Limb Length
ADS-8

| | | 6-inch | 8-inch | 10-inch |
|---|---|---|---|---|
| 2-Dozen Cnt. | Average | 12.7 | 10.6 | 3.9 |
| | Range | 11-14 | 9-11 | 1-10 |
| 3-Dozen Cnt. | Average | 9.0 | 6.8 | 0.3 |
| | Range | 8-10 | 4-9 | 0-2 |
| Hearts | Average | 6.6 | 5.8 | 0 |
| | Range | 5-8 | 3-8 | 0 |

### Example 6

### Number of Limbs Generated by the Method of the Present Invention

Table 6 below shows the average number of limbs and the range using the method of the present invention generated from celery variety Hill's Special (PVP Certificate No. 9500019) from a one and one-half-dozen count stalk, a two-dozen count stalk, a three-dozen count stalk and from a heart stalk. Column 1 shows the size carton, column 2 shows the average number of limbs and the range, column 3 shows average number of limbs and the range that can be generated for a product with a 6-inch specification, column 4 shows the average number of limbs and the range that can be generated for a product with an 8-inch specification, column 5 shows the average number of limbs and the range that can be generated for a product with a 10-inch specification and column 6 shows the average number of limbs and the range that can be generated for a product with a 12-inch specification.

TABLE 6
Celery Limb Number, Average & Range, for Each Limb Length
Hill's Special

| | | 6-inch | 8-inch | 10-inch | 12-inch |
|---|---|---|---|---|---|
| 1.5-Dozen Cnt. | Average | 12.6 | 12.2 | 10.9 | 7.4 |
| | Range | 11-14 | 11-13 | 10-12 | 5-10 |
| 2-Dozen Cnt | Average | 11.1 | 11.1 | 10.3 | 8.4 |
| | Range | 9-12 | 9-12 | 8-12 | 7-10 |
| 3-Dozen Cnt. | Average | 9.7 | 9.4 | 8.3 | 6.6 |
| | Range | 8-12 | 8-12 | 8-10 | 4-9 |
| Hearts | Average | 7.3 | 6.5 | 0 | 0 |
| | Range | 6-9 | 6-8 | 0 | 0 |

### Example 7

### Number of Limbs Generated by the Method of the Present Invention

Table 7 below shows the average number of limbs and the range using the method of the present invention generated from celery variety ADS-13 (U.S. patent application Ser. No. 11/342,477) from a two-dozen count stalk, a three-dozen count stalk and from a heart stalk. Column 1 shows the size carton, column 2 shows the average number of limbs and the range, column 3 shows average number of limbs and the range that can be generated for a product with a 6-inch specification, column 4 shows the average number of limbs and the range that can be generated for a product with an 8-inch specification, column 5 shows the average number of limbs and the range that can be generated for a product with a 10-inch specification, column 6 shows the average number of limbs and the range that can be generated for a product with a 12-inch specification, and column 7 shows the average number of limbs and the range that can be generated for a product with a 14-inch specification.

TABLE 7
Celery Limb Number, Average & Range, for Each Limb Length
ADS-13

| | | 6-inch | 8-inch | 10-inch | 12-inch | 14-inch |
|---|---|---|---|---|---|---|
| 2-Dozen Cnt. | Average | 10.2 | 10.7 | 10.3 | 9.5 | 5.5 |
| | Range | 9-11 | 9-11 | 9-11 | 7-11 | 2-7 |
| 3-Dozen Cnt. | Average | 7.3 | 7.6 | 7.2 | 7.4 | 6.2 |
| | Range | 6-8 | 6-8 | 6-8 | 6-8 | 4-8 |
| Hearts | Average | 7.1 | 7.2 | 0 | 0 | 0 |
| | Range | 6-8 | 6-8 | 0 | 0 | 0 |

### Example 8

### Weight of Limbs Generated Using the Method of the Present Invention

Like the number of limbs that are able to be generated from a single stalk or celery heart, the weight of the product that is able to be generated using the method of the present invention may vary.

It is currently accepted that the acceptable weight range for a carton of 1.5 to 3 dozen count celery is 55 to 65 pounds. Considering the extremes of that weight range and the number of stalks that may be in the carton, the current average weight for a particular stalk of celery may range from 1.5 to 3.6 pounds.

Currently packaged celery hearts are sold on a weight basis. They are available as 12-count (packages) per carton, 1.5 pounds per package or 18-count (packages) per carton at 1 pound per package. A typical 18-count has two stalks per package with an average stalk weight of 0.5 pound. A typical 12-count has 3 stalks per package with an average stalk weight of 0.5 pound. Regardless of the carton size the average stalk weight is 0.5 pound. Table 8 below shows the range of generally acceptable average whole stalk weights for different currently available celery products.

TABLE 8
Weights of Currently Available Celery Products

| | Pounds per stalk | | |
|---|---|---|---|
| | 12-cnt | 18-cnt | 36-cnt |
| 55-pound box | — | 3.1 | 1.5 |
| 65-pound box | — | 3.6 | 1.8 |
| Heart stalk | 0.5 | 0.5 | — |

Using the method of the present invention, celery stalks representing different varieties in the above size ranges were trimmed to meet the specifications of the present invention and the finished product weighed. The extremes for the finished product weighed from 0.11 to 2.35 pounds as shown in Table 9. The average stalk weight ranged from 0.42 to 1.57 pounds per stalk. Column 1 shows the celery variety, column 2 shows the average weight and the range of weight, column 3 shows the weights for a 6-inch limb, column 4 shows the weights for an 8-inch limb, column 5 shows the weights for a 10-inch limb, column 6 shows the weights for a 12-inch limb and column 7 shows the weights for a 14-inch limb.

TABLE 9
Average & Range of Finished Product Weight in Lbs Produced
by the Present Invention

| Variety | | 6-inch | 8-inch | 10-inch | 12-inch | 14-inch |
|---|---|---|---|---|---|---|
| Sonora | Average | 0.99 | 1.26 | 1.4 | 0.42 | 0 |
| | Range | 0.65-1.19 | 0.81-1.54 | 0.83-1.78 | 0.0-0.89 | 0 |
| Hill's Spec | Average | 1.09 | 1.37 | 1.55 | 1.35 | 0 |
| | Range | 0.75-1.52 | 0.93-1.94 | 0.93-2.16 | 0.71-1.92 | 0 |
| ADS-2 | Average | 0.85 | 1.03 | 0.62 | 0 | 0 |
| | Range | 0.71-1.09 | 0.76-1.19 | 0.22-0.94 | 0 | 0 |
| ADS-8 | Average | 0.97 | 1.03 | 0.47 | 0 | 0 |
| | Range | 0.80-1.09 | 0.83-1.21 | 0.11-1.20 | 0 | 0 |
| ADS-12 | Average | 1.00 | 1.26 | 1.49 | 1.57 | 0.90 |
| | Range | 0.87-1.08 | 1.11-1.49 | 1.32-1.83 | 1.23-1.91 | 0.36-1.66 |
| ADS-5 | Average | 0.86 | 1.20 | 1.36 | 1.28 | 0.44 |
| | Range | 0.61-1.24 | 0.77-1.51 | 0.86-1.59 | 0.78-1.68 | 0-1.45 |
| ADS-16 | Average | 0.83 | 1.05 | 1.24 | 1.39 | 1.41 |
| | Range | 0.62-1.03 | 0.77-1.25 | 0.92-1.52 | 0.93-1.70 | 0.99-1.92 |
| ADS-3 | Average | 0.89 | 1.11 | 1.36 | 1.29 | 0.80 |
| | Range | 0.80-1.07 | 0.93-1.36 | 1.06-1.52 | 1.96-1.52 | 0.32-1.18 |
| ADS-4 | Average | 0.74 | 0.93 | 1.12 | 1.23 | 1.25 |
| | Range | 0.58-0.83 | 0.74-1.02 | 0.91-1.21 | 1.04-1.33 | 1.14-1.46 |
| ADS-11 | Average | 0.84 | 1.05 | 1.26 | 1.46 | 1.44 |
| | Range | 0.64-1.11 | 0.78-1.35 | 0.94-1.62 | 1.10-1.82 | 1.23-1.86 |
| ADS-13 | Average | 0.82 | 1.02 | 1.26 | 1.36 | 0.94 |
| | Range | 0.68-0.96 | 0.85-1.18 | 1.07-1.43 | 1.15-1.57 | 0.35-1.26 |
| ADS-17 | Average | 0.75 | 0.97 | 1.20 | 1.42 | 1.62 |
| | Range | 0.46-1.11 | 0.64-1.49 | 0.80-1.79 | 1.08-2.10 | 1.21-2.35 |
| ADS-18 | Average | 0.66 | 0.86 | 1.04 | 1.21 | 1.35 |
| | Range | 0.49-1.04 | 0.66-1.25 | 0.80-1.50 | 0.94-1.73 | 1.07-2.01 |

### Example 9

### Weight of Limbs Generated Using the Method of the Present Invention

Table 10 below shows the average weight and range of limbs in pounds of different varieties generated from celery hearts using the method of the present invention. The extremes for the finished product weighted from 0.23 to 0.68 pounds. The average finished product weight ranged from 0.35 to 0.61 pounds. Column 1 shows the celery variety, column 2 shows the average weight and the range of weight, column 3 shows the weights for a 6-inch limb and column 4 shows the weights for an 8-inch limb.

TABLE 10
Celery Limb Weight in Lbs, Average & Range, for Each Limb Length

| Variety | | 6-inch | 8-inch |
|---|---|---|---|
| Hill's | Average | 0.53 | 0.61 |
| Special | Range | 0.49-0.60 | 0.55-0.68 |
| ADS-2 | Average | 0.35 | 0.34 |
| | Range | 0.28-0.42 | 0.26-0.47 |
| ADS-3 | Average | 0.40 | 0.50 |
| | Range | 0.26-0.47 | 0.34-0.58 |
| ADS-8 | Average | 0.36 | 0.41 |
| | Range | 0.32-0.39 | 0.23-0.49 |
| ADS-13 | Average | 0.41 | 0.51 |
| | Range | 0.39-0.43 | 0.48-0.53 |

### Example 10

### Weight of Limbs Generated Using the Method of the Present Invention

Table 11 below shows the average weight and weight range in pounds for different length limbs generated from different stalk sizes, as represented by stalk count per carton, from Hill's Special using the method of the present invention. The extremes for the finished product weighed from 0.49 to 2.16 pounds while the average finished product weighed from 0.53 to 1.90 pounds. Column 1 shows the size carton, column 2 shows the average number of limbs and the range, column 3 shows average number of limbs and the range that can be generated for a product with a 6-inch specification, column 4 shows the average number of limbs and the range that can be generated for a product with an 8-inch specification, column 5 shows the average number of limbs and the range that can be generated for a product with a 10-inch specification, column 6 shows the average number of limbs and the range that can be generated for a product with a 12-inch specification, and column 7 shows the average number of limbs and the range that can be generated for a product with a 14-inch specification.

TABLE 11
Celery Limb Weight in Lbs, Average & Range, for Each Limb Length
Hill's Special

| | | 6-inch | 8-inch | 10-inch | 12-inch | 14-inch |
|---|---|---|---|---|---|---|
| 1.5-Dozen Cnt. | Average | 1.31 | 1.64 | 1.90 | 1.40 | 0 |
| | Range | 1.12-1.52 | 1.41-1.94 | 1.54-2.16 | 0.86-1.92 | 0 |
| 2-Dozen Cnt | Average | 1.13 | 1.43 | 1.59 | 1.57 | 0 |
| | Range | 1.04-1.30 | 1.30-1.63 | 1.46-1.87 | 1.26-1.76 | 0 |
| 3-Dozen Cnt | Average | 0.84 | 1.04 | 1.15 | 1.09 | 0 |
| | Range | 0.75-0.93 | 0.93-1.15 | 0.93-1.28 | 0.71-1.28 | 0 |
| Hearts | Average | 0.53 | 0.61 | 0 | 0 | 0 |
| | Range | 0.49-0.60 | 0.55-0.68 | 0 | 0 | 0 |

### Example 11

### Weight of Limbs Generated Using the Method of the Present Invention

Table 12 below shows the average weight and weight range in pounds for different length limbs generated from different stalk sizes, as represented by stalk count per carton, from ADS-2 using the method of the present invention. The extremes for the finished product weighed from 0.22 to 1.19 pounds while the average finished product weighed from 0.35 to 1.03 pounds.

TABLE 12
Celery Limb Weight in Lbs, Average & Range, for Each Limb Length
ADS-2

| | | | | | 12- | 14- |
|---|---|---|---|---|---|---|
| | | 6-inch | 8-inch | 10-inch | inch | inch |
| 2-Dozen Cnt | Average | 0.85 | 1.03 | 0.62 | 0 | 0 |
| | Range | 0.71-1.00 | 0.76-1.19 | 0.22-0.94 | 0 | 0 |
| 3-Dozen Cnt | Average | 0.59 | 0.70 | 0.49 | 0 | 0 |
| | Range | 0.54-0.71 | 0.58-0.89 | 0.28-0.66 | 0 | 0 |
| Hearts | Average | 0.35 | 0.39 | 0 | 0 | 0 |
| | Range | 0.28-0.42 | 0.26-0.47 | 0 | 0 | 0 |

The data in Tables 8-12 demonstrate that the range of weights for a finished product of the present invention, regardless of the customer's length specifications, will range from 0.25 to 1.6 pounds.

The method of the present invention provides an important replacement for whole stalk celery and embodies the whole stalk minus the less desirable portions of whole stalk celery (i.e. leaf, heart, butt). By eliminating the heart, foliage, basal plate or butt of the plant and, depending on the customer, a portion of the flare, the present invention not only is an improved product but also, the weight of the present invention is significantly reduced compared to the original stalks from which it was generated. This provides an unexpected additional advantage of reducing shipment costs.

By creating a product which includes only the most desirable portion of the celery stalk, the limbs, the product volume is significantly reduced. This is also very beneficial to the consumer because there is less space utilized in the refrigerator for storage. It is also beneficial to the customer because it takes up less space on the produce display in the store and reduces cost. By removing the leaves and the growing point from the celery unexpectedly the quality of this finished product is improved. Even under conditions of refrigeration a celery stalk containing the growing point, which is a part of the heart and exists at the center of the butt, is still a living organism. When cut or injured a celery stalk begins translocating its nutritional reserves and sugars from the outside limbs to the growing point in order to sustain life. While under refrigeration this process is slowed but it does not cease. By removing the butt, heart and leaves there is nowhere for these reserves to be translocated and the quality of the preferred portion of the celery stalk for consumption is improved.

While a number of exemplary aspects and embodiments have been discussed above, those of skill in the art will recognize certain modifications, permutations, additions, and sub-combinations thereof. It is therefore intended that the following appended claims and claims hereafter introduced are interpreted to include all such modifications, permutations, additions, and sub-combinations as are within their true spirit and scope.

What is claimed is:

1. A method for producing a ready-to-eat celery product, comprising the steps of
a. cutting celery to remove leaves;
b. cutting celery to remove entire attachment to butt of celery;
c. removing heart of celery;
d. cutting celery into limb lengths between 6 and 14 inches;
e. sanitizing celery; and
f. packaging celery.

2. A ready-to-eat celery product produced by the method of claim 1.

3. The method of claim 1, wherein said celery is selected from the group consisting of ADS-2, ADS-3, ADS-4, ADS-5, ADS-7, ADS-8, ADS-11, ADS-12, ADS-13, ADS-16, ADS-17 and ADS-18.

4. A ready-to-eat celery product produced by the method of claim 1, wherein the limb length of the product is between 6 and 8 inches long.

5. A ready-to-eat celery product produced by the method of claim 1, wherein the limb length of the product is between 8 and 10 inches long.

6. A ready-to-eat celery product produced by the method of claim 1, wherein the limb length of the product is between 10 and 12 inches long.

7. A ready-to-eat celery product produced by the method of claim 1, wherein the limb length of the product is between 12 and 14 inches long.

8. A ready-to-eat celery product produced by the method of claim 1, wherein the weight of the product is between 0.25 and 1.6 pounds.

9. A ready-to-eat celery product produced by the method of claim 1, wherein cutting said celery is performed by an object selected from the group consisting of knives, razor sharp blades, saws, water jets, lasers and sound waves.

10. A ready-to-eat celery product produced by the method of claim 1, wherein sanitizing said celery is performed by a sanitization treatment selected from the group consisting of ascorbic acid, peroxyacetic acid, sodium hypochlorite (chlorine), bromine products (sodium hypobromine), chlorine dioxide, ozone based systems, hydrogen peroxide products, trisodium phosphate, quaternary ammonium products, ultraviolet light systems, irradiation, steam, ultra heat treatments, and high pressure pasteurization.

11. A ready-to-eat celery product produced by the method of claim 1, wherein said celery product is packaged in a package selected from the group consisting of flexible film, rigid plastic, solid fiber, poly sleeves, plastic sleeves, poly bags, plastic bags, natural decomposable bags, natural decomposable sleeves, packages that may be opened and resealed, rigid containers like clam shells, packages with different permeability properties, packages with built-in vents and packages with specialized pores or any combination thereof.

12. A method for producing a ready-to-eat celery product, comprising the steps of
a. cutting celery to simultaneously remove leaves and entire attachment to butt of celery;
b. removing heart of celery;
c. cutting celery into limb lengths between 6 and 14 inches;
d. sanitizing celery; and
e. packaging celery.

13. A ready-to-eat celery product produced by the method of claim 12.

14. The method of claim 12, wherein said celery is selected from the group consisting of ADS-2, ADS-3, ADS-4, ADS-5, ADS-7, ADS-8, ADS-11, ADS-12, ADS-13, ADS-16, ADS-17 and ADS-18.

15. A ready-to-eat celery product produced by the method of claim 12, wherein the limb length of the product is between 6 and 8 inches long.

16. A ready-to-eat celery product produced by the method of claim 12, wherein the limb length of the product is between 8 and 10 inches long.

17. A ready-to-eat celery product produced by the method of claim 12, wherein the limb length of the product is between 10 and 12 inches long.

18. A ready-to-eat celery product produced by the method of claim 12, wherein the limb length of the product is between 12 and 14 inches long.

19. A ready-to-eat celery product produced by the method of claim 12, wherein the weight of the product is between 0.25 and 1.6 pounds.

20. A ready-to-eat celery product produced by the method of claim 12, wherein cutting said celery is performed by an object selected from the group consisting of knives, razor sharp blades, saws, water jets, lasers and sound waves.

21. A ready-to-eat celery product produced by the method of claim 12, wherein sanitizing said celery is performed by a sanitization treatment selected from the group consisting of ascorbic acid, peroxyacetic acid, sodium hypochlorite (chlorine), bromine products (sodium hypobromine), chlorine dioxide, ozone based systems, hydrogen peroxide products, trisodium phosphate, quaternary ammonium products, ultraviolet light systems, irradiation, steam, ultra heat treatments, and high pressure pasteurization.

22. A ready-to-eat celery product produced by the method of claim 12, wherein said celery product is packaged in a package selected from the group consisting of flexible film, rigid plastic, solid fiber, poly sleeves, plastic sleeves, poly bags, plastic bags, natural decomposable bags, natural decomposable sleeves, packages that may be open and resealed, rigid containers like clam shells, packages with different permeability properties, packages with built-in vents and packages with specialized pores or any combination thereof.

23. A ready-to-eat celery product wherein the limb length of the product is between 6 and 8 inches and the celery is selected from the group consisting of ADS-2, ADS-3, ADS-4, ADS-5, ADS-7, ADS-8, ADS-11, ADS-12, ADS-13, ADS-16, ADS-17 and ADS-18.

24. A ready-to-eat celery product wherein the limb length of the product is between 8 and 10 inches and the celery is selected from the group consisting of ADS-2, ADS-3, ADS-4, ADS-5, ADS-7, ADS-8, ADS-11, ADS-12, ADS-13, ADS-16, ADS-17 and ADS-18.

25. A ready-to-eat celery product wherein the limb length of the product is between 10 and 12 inches and the celery is selected from the group consisting of ADS-2, ADS-3, ADS-4, ADS-5, ADS-7, ADS-8, ADS-11, ADS-12, ADS-13, ADS-16, ADS-17 and ADS-18.

26. A ready-to-eat celery product wherein the limb length of the product is between 12 and 14 inches and the celery is selected from the group consisting of ADS-2, ADS-3, ADS-4, ADS-5, ADS-7, ADS-8, ADS-11, ADS-12, ADS-13, ADS-16, ADS-17 and ADS-18.
